(19) United States
(12) Patent Application Publication
(10) Pub. No.: US 2023/0398582 A1
(43) Pub. Date: Dec. 14, 2023

(54) METHODS FOR REMOVING DIRT DEPOSITS ON AT LEAST ONE GEOMETRIC STRUCTURE, PRODUCED BY MEANS OF MICROTECHNOLOGY AND/OR NANOTECHNOLOGY, OF AT LEAST ONE BODY AND USE OF AN ULTRA-SHORT PULSED LASER WITH PULSES IN BURST MODE

(71) Applicant: HOCHSCHULE MITTWEIDA (FH), Mittweida (DE)

(72) Inventors: Steffen WEISSMANTEL, Chemnitz (DE); Peter LICKSCHAT, Parthenstein (DE); Daniel METZNER, Chemnitz (DE)

(73) Assignee: ACSYS LASERTECHNIK GMBH, Kornwestheim (DE)

(21) Appl. No.: 18/252,483

(22) PCT Filed: Nov. 11, 2021
(86) PCT No.: PCT/DE2021/000187

§ 371 Date: May 10, 2023

(30) Foreign Application Priority Data
Nov. 12, 2020 (DE) 10 2020 007 017.5

(51) Int. Cl. B08B 7/00; B23K 26/0622; B23K 26/362

(52) U.S. Cl. CPC B08B 7/0042; B23K 26/0624; B23K 26/362

(57) ABSTRACT

The invention relates to methods for removing dirt deposits on at least one geometric structure of at least one body, said geometric structure being produced by means of microtechnology and/or nanotechnology, wherein the dirt deposits are dirt deposits resulting from an ablation or evaporation of material during creation of the geometric structure; and uses of an ultra-short pulsed laser with pulses in burst mode.

The methods for removing dirt deposits and the uses of an ultra-short pulsed laser with pulses in the burst mode are characterized more particularly in that the resulting dirt deposits are easy to remove. Ultra-short pulsed laser irradiation is applied from a laser onto the geometric structure with pulses in the burst mode to remove the dirt deposits.

The invention relates to methods for removing dirt deposits (debris) on at least one geometric structure of at least one body, said geometric structure being produced by means of microtechnology and/or nanotechnology, wherein the dirt deposits are dirt deposits resulting from an ablation or evaporation of material during the creation of the geometric structure; and uses of an ultra-short pulsed laser with pulses in burst mode.

When producing geometric structures by ablation or evaporation of material, dirt deposits can be produced on the geometric structures. These can be removed by dry ice blasting, glass bead blasting, plasma polishing or wet chemical etching. When using dry ice blasting, there is the possibility that not all the generated debris can be removed. When using glass bead blasting, plasma polishing and wet chemical etching, the material under the debris may also be partially removed, as a result of which contours of the geometric structures are rounded or not retained. When using plasma polishing and wet chemical etching, in particular chemical waste products are also produced. Furthermore, plasma polishing only works for metals and metal alloys.

US 2001/0 009 250 A1 discloses a method for laser processing or laser modification of materials, wherein a combination of ultra-fast laser pulses and bursts having a high repetition rate are used for material processing. One mentioned application is drilling a through-hole into a foil by means of a single burst, followed by an additional shot to clear the debris from the borehole. However, the removal of the debris and therefore the cleaning is not accomplished by removing the above-mentioned debris, but by increasing the diameter of the through-hole. Furthermore, it is pointed out that, by suitably selecting the laser parameters depending on the hole diameter, considerable melt debris can be avoided by ejecting material.

Cleaning by removing dirt deposits (debris) on at least one geometric structure of at least one body, which geometric structure is produced by means of microtechnology and/or nanotechnology, is not the subject of this document.

US 2007/0 272 667 A1 discloses micromachining with short-pulsed ultraviolet laser radiation in order to increase the throughput for laser micromachining microelectronic production materials. Among other things, this concerns the cleaning of solder pads by specifically removing an epoxy resin layer on soldering points.

For this purpose, single-pulsed laser radiation in the UV range is used to remove these layers. The layers result from solder resist masks which are removed so that the soldering point is not damaged. This soldering point therefore cannot be subsequently re-soldered. The relevant layer is ablated by evaporation. Removal of dirt deposits is not the subject of this document.

DE 10 2019 219 121 A1 relates to a method for removing material from a surface. The document refers to smoothing undesirable surface structures that appear as cone-like protrusions at high fluences. These form a foam-like structure and therefore reduce the quality of a treated surface. The surface is exposed to high-frequency pulse packets, wherein smoothing of the surface takes place by means of thermal effects and/or melting effects.

The removal of deposits cannot be deduced from this document.

US 2010/0 096 371 A1 includes a method for the continuous cleaning of flexible sheets transported on a belt.

In order to be able to accomplish large areas, the laser beam is geometrically separated by means of beam splitters, and a large-area raster is therefore produced. In this process, a layer is removed over a large area by spallation, wherein the pulse itself generates shock waves to remove the layer.

The method is limited to flat and flexible sheets which are transported on a conveyor belt. An Nd:YAG laser having pulse durations in the nanosecond range is used as the laser.

US 2007/0 251 543 A1 discloses a method for cleaning material surfaces which focuses on the cleaning of lithographic apparatuses or substrate cleaning. The method is performed in a vacuum chamber. For cleaning, a shock wave is generated by thermal expansion in the material so that thermally induced material removal is initiated.

For this purpose, in particular pulses in the nanosecond range are used to generate a shock wave in the material. A plurality of pulses in the nanosecond range can be used to process a surface.

US 2006/0 108 330 A1 relates to cleaning surfaces by means of a plasma-induced shock wave. For this purpose, a plasma is ignited near the material surface, and the emitted shock wave cleans the surface. In this process, a protective layer of, for example, gold, silver, platinum or rhodium is used between the plasma and the surface to be cleaned as a result of the essentially thermal process.

The invention disclosed in claims 1 and 6 is based on the object of easily removing dirt deposits resulting from an ablation or evaporation of material during the creation of geometric structures by means of microtechnology and/or nanotechnology.

This object is achieved by means of the features listed in claims 1 and 6.

The methods for removing dirt deposits (debris) on at least one geometric structure of at least one body, said geometric structure being produced by means of microtechnology and/or nanotechnology, wherein the dirt deposits are dirt deposits resulting from an ablation or evaporation of material during creation of the geometric structure, and the uses of an ultra-short pulsed laser with pulses in the burst mode are characterized in particular in that the resulting dirt deposits are easily removable.

For this purpose, the geometric structure of the body is exposed to ultra-short pulsed laser irradiation from a laser having pulses in the burst mode to remove the dirt deposits.

The ultra-short pulsed laser irradiation from the laser having pulses in the burst mode is used to remove dirt deposits (debris) on at least one geometric structure, said geometric structure being produced by means of microtechnology and/or nanotechnology, wherein the dirt deposits are dirt deposits resulting from an ablation or evaporation of material during creation of the geometric structure.

Burst mode is a laser technology in which pulse groups having a defined number of pulses per group (a pulse group is a burst) and a defined amount of pulse energy per pulse in a group interact with the material surface. The pulse repetition frequency in a burst can be greater than/equal to 1 GHz. The pulse duration of a pulse in a group can be equal to/less than 1 ns. By means of a relative movement between the laser irradiation and the material surface, the pulse groups can be moved at a defined burst repetition frequency on the material.

The first pulse of the pulse group generates a plasma on the dirt deposits (debris). A pulse group is thus a burst. Due to the very short pulse repetition time of a few to several picoseconds, the following pulse interacts with this plasma. This induces a strong shock wave, and the dirt deposits (debris) are removed by the pressure wave.

The number of shock waves can be regulated with the number of pulses in the burst. The force of the shock wave can be regulated with the pulse duration and the fluence per pulse.

The method for removing dirt deposits and the use of an ultra-short pulsed laser with pulses in the burst mode are further characterized in that only a small to no amount of material is removed, whereby the target values of the geometric structure are approximately maintained. Chemical waste products are not produced.

Advantageously, during and after the method for removing dirt deposits and the use of an ultra-short pulsed laser having pulses in the burst mode, little to no heat-affected zones are produced in the geometric structure.

Thus, the method for removing dirt deposits or the use of an ultra-short pulsed laser with pulses in the burst mode can advantageously be applied in microelectronics, microsystem engineering and microprocess engineering for cleaning the geometric structures produced thereby.

In microsystem engineering, geometric structures can be in particular mechanical, optical, chemical or biochemical components.

The method for removing dirt deposits or the use of an ultra-short pulsed laser with pulses in the burst mode is a highly selective cleaning method.

Advantageous embodiments of the invention are given in the dependent claims.

In one embodiment, the pulse repetition frequency in a burst can be equal to/greater than 1 GHz, and the pulse duration of a pulse in a burst can be less than/equal to 1 ns.

In one embodiment, a plasma is generated on the debris by a first pulse of the burst (pulse group). By means of the interaction of at least one following pulse or following pulses of the burst with the plasma, a shock wave as a pressure wave or shock waves as pressure waves is/are induced on the at least one dirt deposit, and the dirt deposit is removed.

In one embodiment, the number of shock waves can be determined by the number of following pulses in the burst.

The force of the shock wave can be determined in one embodiment by the pulse duration and the fluence per following pulse.

To remove dirt deposits, in one embodiment, ultra-short pulsed laser irradiation from the laser can be used with pulses in the burst mode having a pulse repetition frequency in a burst equal to/greater than 1 GHz and a pulse duration of a pulse in a burst equal to/less than 1 ns.

A plasma generated on the debris by a first pulse of the burst (pulse group, pulse train) and a shock wave as a pressure wave induced by the interaction of at least one following pulse or following pulses of the burst with the plasma and acting on the at least one dirt deposit is used in one embodiment to remove the dirt deposit.

To remove dirt deposits, in one embodiment, the laser having the ultra-short pulsed laser irradiation and at least one scanner for guiding the laser irradiation and/or a drive connected to a carrier of the body may be used. By means of a relative movement between the laser irradiation and the material surface that can be realized in this way, the pulse groups can be moved on the material with a defined burst repetition frequency.

In order to implement the invention, it is also expedient to combine the above-described embodiments and features of the claims.

An embodiment of the invention is shown in principle in each of the drawings and is described in more detail below. The exemplary embodiment is intended to describe the invention without limiting it.

In the drawings:

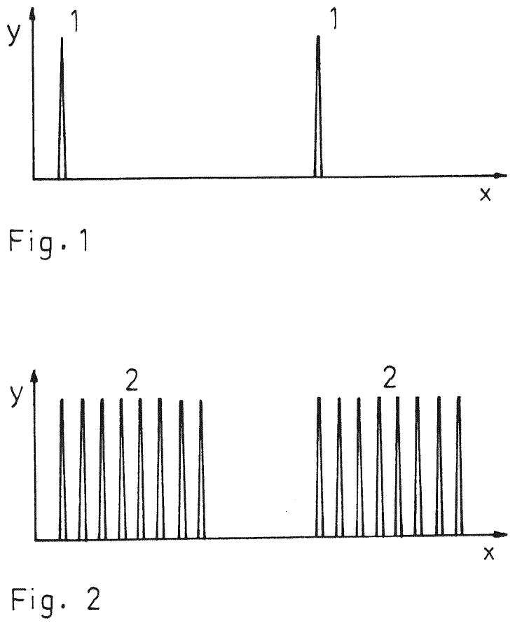

FIG. 1 shows a schematic representation of pulsed laser irradiation with a single pulse mode,

FIG. 2 shows a schematic representation of pulsed laser irradiation with a burst mode; and

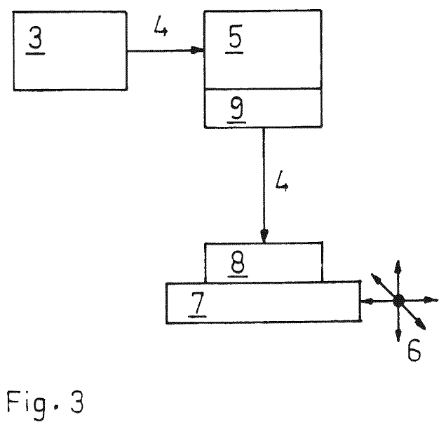

FIG. 3 shows a device for removing dirt deposits.

In the following exemplary embodiment, a method for removing dirt deposits (debris) on at least one geometric structure of at least one body 8, said geometric structure being produced by means of microtechnology and/or nanotechnology, wherein the dirt deposits are dirt deposits resulting from an ablation or evaporation of material during the creation of the geometric structure, and a use of an ultra-short pulsed laser 3 with pulses in the burst mode are explained together in more detail.

For this purpose, FIG. 1 shows a schematic representation of pulsed laser irradiation with a single pulse mode, and FIG. 2 shows a schematic representation of pulsed laser irradiation with a burst mode.

The burst mode is a laser technology in which pulse groups 2 having a defined number of pulses per pulse group 2 and a defined amount of pulse energy per pulse in a pulse group 2 interact with the material surface. A pulse group 2 is a burst. The pulse repetition frequency in a burst is greater than/equal to 1 GHz.

The pulse duration of a pulse in a pulse group 2 is equal to/less than 1 ns. FIG. 1 shows two individual pulses 1 with the pulse energy y as a function of time x. In FIG. 2, two pulse groups 2 and therefore two bursts with the pulse energy y as a function of time x are shown.

The first pulse of pulse group 2 of a pulse train (burst) generates a plasma on the debris. Due to the very short pulse repetition time of a few to several picoseconds, the following pulse interacts with this plasma. This induces a strong shock wave, and the debris is removed by a primarily mechanical process.

The number of shock waves can be regulated with the number of pulses in the burst. The force of the shock wave can be regulated with the pulse duration and the fluence per pulse.

FIG. 3 shows a device for removing dirt deposits in a basic illustration.

To remove dirt deposits, the laser 3 with the ultra-short pulsed laser irradiation 4 and at least one scanner 5 for guiding the laser irradiation 4 and/or at least one drive 6 as a movement mechanism connected to a carrier 7 of the body 8 can be used.

Using a scanner 5 and a downstream f-theta lens 9, the laser irradiation 4 can be guided over the surface of the geometric structure of the body 8. The f-theta lens 9 focuses the laser irradiation 4 on the focal point and, during scanning, causes the focal point to always lie in the working plane perpendicular to the optical axis of the f-theta lens 9. Furthermore, the position in the working plane approximately follows the f-theta condition; the scan length (image height) is approximately proportional to the set scan angle. The drive 6 can in particular be a device for movement in at least one direction of the carrier.

1. A method for removing dirt deposits (debris) on at least one geometric structure of at least one body (8), said geometric structure being produced by means of microtechnology and/or nanotechnology, wherein the dirt deposits are dirt deposits resulting from an ablation or evaporation of material during creation of the geometric structure, characterized in that the geometric structure is exposed to ultra-short pulsed laser irradiation (4) from a laser (3) with pulses in burst mode to remove the dirt deposits.

2. The method according to claim 1, characterized in that the pulse repetition frequency in a burst is equal to/greater than 1 GHz and the pulse duration of a pulse in a burst is less than/equal to 1 ns.

3. The method according to claim 1, characterized in that a plasma is generated on the debris by a first pulse of the burst, and, by means of the interaction of at least one following pulse or following pulses of the burst with the plasma, a shock wave or shock waves is/are induced on the at least one dirt deposit, and the dirt deposit is removed.

4. The method according to claim 1, characterized in that the number of shock waves is determined by the number of following pulses in the burst.

5. The method according to claim 1, wherein the force of the shock wave is determined by the pulse duration and the fluence per following pulse.

6-9. (canceled)

10. The method according to claim 3, characterized in that the number of shock waves is determined by the number of following pulses in the burst.

11. The method according to claim 3, wherein the force of the shock wave is determined by the pulse duration and the fluence per following pulse.
